(19) United States
(12) Patent Application Publication
(10) Pub. No.: US 2018/0131877 A1
(43) Pub. Date: May 10, 2018

(54) IMAGE DISPLAY DEVICE FOR VEHICLE AND IMAGE DISPLAY PROGRAM FOR VEHICLE

(71) Applicant: TOYOTA JIDOSHA KABUSHIKI KAISHA, Toyota-shi (JP)

(72) Inventors: Masaaki AMANO, Nagoya-shi (JP); Goro ASAI, Toyota-shi (JP)

(73) Assignee: TOYOTA JIDOSHA KABUSHIKI KAISHA, Toyota-shi (JP)

(21) Appl. No.: 15/700,582

(22) Filed: Sep. 11, 2017

(30) Foreign Application Priority Data
Nov. 8, 2016 (JP) 2016-218142

(51) Int. Cl. H04N 5/243; B60R 1/00; H04N 5/232

(52) U.S. Cl. CPC H04N 5/243; B60R 1/00; H04N 5/23293; H04N 5/247; B60R 2300/207; B60R 2300/30; B60R 2300/105

(57) ABSTRACT

An image display device for a vehicle, the device includes an imaging unit capturing images of a periphery of a vehicle; first display unit displaying captured images by the imaging unit; second display unit; detecting unit detecting brightness of the periphery of the vehicle; and a control unit configured to carry out display control, in a case in which brightness that is greater than or equal to a predetermined luminance raising threshold value is detected by the detecting unit, so as to simultaneously raise respective luminances of the first display unit and the second display unit, and to carry out display control, in a case in which brightness that is less than a predetermined luminance lowering threshold value, which is less than or equal to the luminance raising threshold value, is detected, so as to simultaneously lower the respective luminances of the first display unit and the second display unit.

### CROSS-REFERENCE TO RELATED APPLICATION

This application claims priority under 35 USC 119 from Japanese Patent Application No. 2016-218142 filed Nov. 8, 2016, the disclosure of which is incorporated by reference herein in its entirety.

### BACKGROUND

### Technical Field

Preferred embodiments relate to an image display device for a vehicle and an image display program for a vehicle that are installed in a vehicle and that display captured images of a periphery of the vehicle and various types of information.

### Related Art

There are known image display devices for a vehicle that enable viewing of the periphery of a vehicle by capturing images of the periphery of the vehicle such as the vehicle rear region or the vehicle lateral rear regions or the like by an imaging unit such as a camera or the like, and displaying the captured images on a display unit such as a monitor or the like that is within the vehicle cabin.

For example, Japanese Patent Application Laid-Open (JP-A) No. 2010-208372 proposes displaying on a monitor images of the vehicle rear region that have been captured by a camera, and adjusting the luminance of the monitor in accordance with the brightness of the region imaged by the camera.

Further, JP-A No. 2005-343332 proposes a technique of adjusting the luminance of a monitor of a multimedia system, such as an on-board DVD system or the like, in accordance with the brightness of the periphery of the vehicle.

### SUMMARY

Employing an image display device for a vehicle, such as that of JP-A No. 2010-208372 that enables viewing of the periphery of the vehicle, in a vehicle in which a multimedia system such as that of JP-A No. 2005-343332 is installed, and carrying out display on respectively different display units, has been supposed. In a case in which plural display units are installed in a vehicle in this way, there is the concern that the vehicle occupant will be made to feel a sense of incongruity if the timings of adjusting the luminances of the respective display units are offset from one another.

Preferred embodiments propose that the sense of incongruity, which is due to offset of timings of the respective luminance adjustments of plural display units, is suppressed. The plural display units include a display unit for viewing the periphery of the vehicle and a display unit that is provided separately from this display unit.

An image display device for a vehicle, the image display device of a first aspect of the disclosure includes: an imaging unit provided within a vehicle cabin and capturing images of a periphery of a vehicle; a first display unit displaying the images that have been captured by the imaging unit; a second display unit provided within the vehicle cabin separately from the first display unit; a detecting unit detecting brightness of the periphery of the vehicle; and a control unit configured to carry out display control, in a case in which brightness that is greater than or equal to a predetermined luminance raising threshold value is detected by the detecting unit, so as to simultaneously raise respective luminances of the first display unit and the second display unit, and to carry out display control, in a case in which brightness that is less than a predetermined luminance lowering threshold value, which is less than or equal to the luminance raising threshold value, is detected by the detecting unit, so as to simultaneously lower the respective luminances of the first display unit and the second display unit.

In accordance with the image display device for a vehicle of the first aspect, the first display unit is provided within the vehicle cabin, and captured images of a periphery of a vehicle, which have been captured by the imaging unit, are displayed thereon.

The second display unit is provided within the vehicle cabin separately from the first display unit. The second display unit displays, for example, images that are read-out from any of various types of media, and information for operating the air conditioner and the audio device and the like of the vehicle, and the like.

The brightness of the periphery of the vehicle is detected at the detecting unit. The detecting unit detects, as an example of the brightness, the illumination of the periphery of the vehicle by an illumination sensor or the like.

Further, at the control section, display control is carried out, in a case in which brightness that is greater than or equal to a predetermined luminance raising threshold value is detected by the detecting unit, so as to simultaneously raise the respective luminances of the first display unit and the second display unit, and display control is carried out, in a case in which brightness that is less than a predetermined luminance lowering threshold value, which is less than or equal to the luminance raising threshold value, is detected by the detecting unit, so as to simultaneously lower the respective luminances of the first display unit and the second display unit. Namely, because luminance adjustment of the first display unit and the second display unit are carried out simultaneously, a sense of incongruity that is due to offset in the luminance adjustment timings of the respective display units can be suppressed.

Note that the same value may be used for the luminance raising threshold value and the luminance lowering threshold value, but it is preferable to set the luminance lowering threshold value that is lower than the luminance raising threshold value, in consideration of hysteresis of the control.

Further, “simultaneously” is not limited to exactly the same time, and includes offset of a range that is such that a person cannot perceive the offset in the timings of the changing of the luminances of the respective display units.

In an image display device for a vehicle of a second aspect of the disclosure, in the first aspect, the imaging unit may capture images of a rear region as the periphery of the vehicle, by a camera provided at a vehicle rear portion, and the first display unit may display, on a display screen that is disposed at an upper portion of a vehicle front region within the vehicle cabin, the images of the vehicle rear region that have been captured by the imaging unit. Due thereto, the first display unit can be made to function as a rearview mirror.

In an image display device for a vehicle of a third aspect of the disclosure, in the first aspect or the second aspect, the imaging unit may capture images of vehicle lateral rear regions via side cameras provided at vehicle left and right sides, and the first display unit may display, on a pair of side display screens that are disposed respectively at a left and a right of a front region within the vehicle cabin, respective captured images of the vehicle lateral rear region at the vehicle left side and of the vehicle lateral rear region at the vehicle right side, which have been captured by the imaging unit. Due thereto, the first display unit can be made to function as outer mirrors.

A non-transitory recording medium of a fourth aspect of the disclosure stores a program, the program is executable by a computer to perform an image display process for a vehicle. The process includes: capturing images of a periphery of a vehicle; displaying, on a first display unit, images that have been captured; displaying, on a second display unit, information that is different from the captured images; detecting brightness of the periphery of the vehicle; and in a case in which brightness that is greater than or equal to a predetermined luminance raising threshold value is detected, simultaneously raising respective luminances of the first display unit and the second display unit, and, in a case in which brightness that is less than a predetermined luminance lowering threshold value, which is less than or equal to the luminance raising threshold value, is detected, simultaneously lowering the respective luminances of the first display unit and the second display unit.

As described above, in accordance with the present disclosure, there is the effect of being able to reduce the feeling of incongruity that is due to offset of timings of the respective luminance adjustments of a display unit for viewing the periphery of the vehicle and a display unit that is provided separately from this display unit.

### BRIEF DESCRIPTION OF THE DRAWINGS

Preferred embodiments will be described in detail based on the following figures, wherein:

FIG. 1A is a drawing showing schematic installed positions of an image display device at a vehicle front side of a vehicle relating to a present embodiment;

FIG. 1B is a drawing showing schematic installed positions of an image display device at a vehicle rear side of a vehicle relating to a present embodiment;

FIG. 2 is a drawing showing the installed positions within a vehicle cabin of the image display device for a vehicle relating to the present embodiment;

FIG. 3 is a block drawing showing the schematic structure of a control system of the image display device for a vehicle relating to the present embodiment;

FIG. 4 is a flowchart showing an example of display control that is carried out at a control device of the image display device for a vehicle relating to the present embodiment; and

FIG. 5 is a drawing for explaining an example in which there are a first through a third luminance raising threshold value, and there are a first through a third luminance lowering threshold value, and adjustment to a first through a fourth luminance is possible.

### DETAILED DESCRIPTION

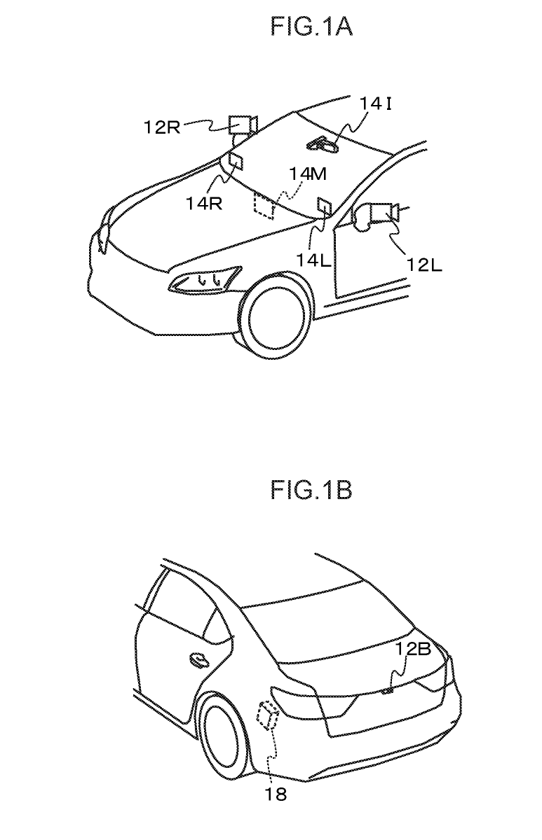

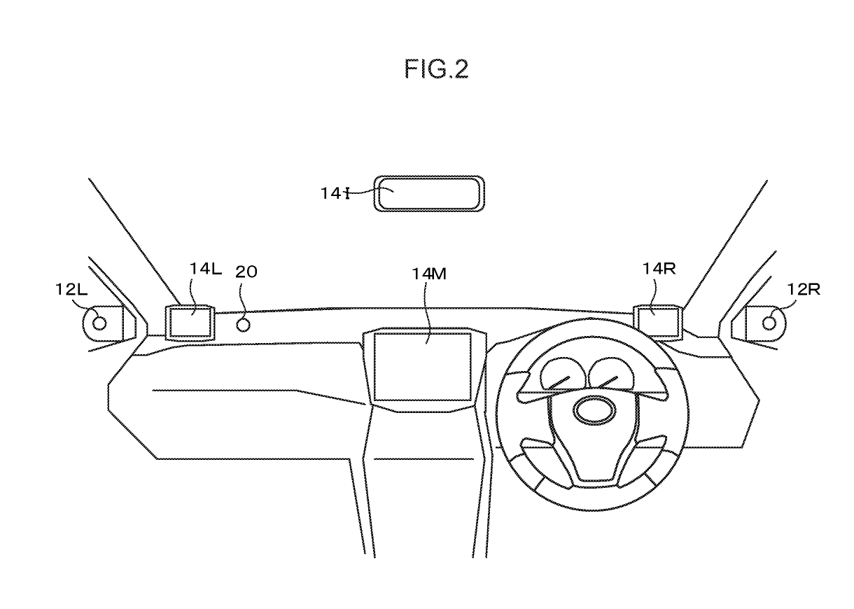

An example of an embodiment of the present disclosure is described in detail hereinafter with reference to the drawings. FIG. 1A and FIG. 1B are drawings showing schematic installed positions in a vehicle of an image display device for a vehicle relating to the present embodiment. FIG. 1A shows the vehicle front side, and FIG. 1B shows the vehicle rear side. FIG. 2 is a drawing showing specific installed positions within a vehicle cabin of the image display device relating to the present embodiment.

The image display device relating to the present embodiment captures images of the vehicle rear region by a rear camera 12B that is provided at the vehicle rear portion, and displays the captured images on a rearview mirror monitor 14I that is provided at the position of a rearview mirror within the vehicle cabin. By providing the rearview mirror monitor 14I at the position of the rearview mirror, the rearview mirror monitor 14I can be made to function as the rearview mirror.

Further, the vehicle lateral rear regions are imaged by lateral rear cameras (a right lateral rear camera 12R and a left lateral rear camera 12L) that are provided at the outer sides of the vehicle front side end at the vertical direction intermediate portions of the front side doors of the vehicle. The captured images are displayed on respective right side monitor 14R and left side monitor 14L. The right side monitor 14R and the left side monitor 14L can be made to function as outer mirrors by providing the right side monitor 14R and the left side monitor 14L respectively at the left and right of a front portion (e.g., the instrument panel) of the vehicle cabin interior. Note that, in the present embodiment, as shown in FIG. 2, an example is shown in which the right side monitor 14R and the left side monitor 14L are provided in vicinities of the lower ends of the front pillars respectively, but the placement thereof is not limited to this. For example, the right side monitor 14R and the left side monitor 14L may be provided respectively at the left and right door trims that serve as the vehicle cabin interior.

Further, a multimedia monitor 14M is disposed at the central portion of the instrument panel. The multimedia monitor 14M displays images that are read-out from any of various types of media such as, for example, a DVD (Digital Versatile Disc) or a USB (Universal Serial Bus) memory or the like, and displays information for operating the air conditioner and the audio device, and the like. Note that the images of the periphery of the vehicle that are captured by the rear camera 12B and the lateral rear cameras may be displayed on the multimedia monitor 14M.

Note that the rear camera 12B, the right lateral rear camera 12R and the left lateral rear camera 12L correspond to examples of the imaging unit. Further, the rearview mirror monitor 14I, the right side monitor 14R, and the left side monitor 14L correspond to examples of the first display unit, and the multimedia monitor 14M corresponds to an example of the second display unit.

Further, an illumination sensor 20, which serves as an example of a detecting unit that detects the brightness of the periphery, is provided at a position that is at the vehicle front side of the upper surface of the instrument panel.

A control device 18, which serves as an example of a control section that controls the respective cameras and monitors, is provided within the trunk. Although the control device 18 provided within the trunk is described as an example, the placement of the control device 18 is not limited to this, and the control device 18 may be provided at another place within the vehicle cabin.

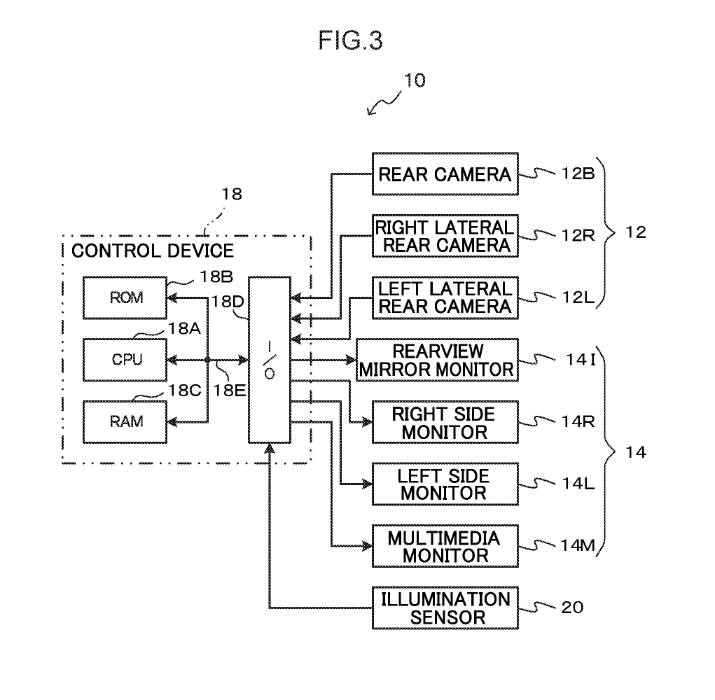

FIG. 3 is a block drawing showing the schematic structure of the control system of an image display device 10 for a vehicle relating to the present embodiment.

The image display device 10 for a vehicle relating to the present embodiment has the plural cameras 12, the plural monitors 14, the illumination sensor 20, and the control device 18. As described above, the rear camera 12B, the right lateral rear camera 12R and the left lateral rear camera 12L are the plural cameras 12, and the right side monitor 14R, the left side monitor 14L and the multimedia monitor 14M are the plural monitors 14.

The rear camera 12B outputs results of imaging, in which images of the vehicle rear region have been captured, to the control device 18. The rear camera 12B is disposed, for example, at the exterior of the vehicle (e.g., at the trunk that is shown in FIG. 1, or the like), and captures images of the vehicle rear region as the periphery of the vehicle. Note that, in the present embodiment, an example in which the rear camera 12B is provided at the exterior of the vehicle is described, but the rear camera 12B may be provided at the vehicle cabin interior.

The right lateral rear camera 12R outputs to the control device 18 the results of imaging in which images of the right lateral rear region of the vehicle are captured. The left lateral rear camera 12L outputs to the control device 18 the results of imaging in which images of the left lateral rear region of the vehicle are captured. As shown in FIG. 2, the right lateral rear camera 12R and the left lateral rear camera 12L respectively are disposed at the positions of the outer mirrors, and capture images of the lateral rear regions of the vehicle as the periphery of the vehicle. Note that the right lateral rear camera 12R and the left lateral rear camera 12L respectively may be provided at other positions such as at the fender or the like.

Captured images of the vehicle rear region, which have been captured by the rear camera 12B, are displayed on the rearview mirror monitor 14I by control of the control device 18. Note that the rearview mirror monitor 14I continuously displays captured images of the vehicle rear region, and is different from a so-called back monitor that senses backing-up of the vehicle and displays captured images of the vehicle rear region temporarily at the time of backing-up.

Captured images of the vehicle right lateral rear region that have been captured by the right lateral rear camera 12R are displayed on the right side monitor 14R by control of the control device 18. Captured images of the vehicle left lateral rear region that have been captured by the left lateral rear camera 12L are displayed on the left side monitor 14L by control of the control device 18.

Images that are read-out from any of various types of media such as DVDs or the like, information for operating the air conditioner, information for operating the audio device, and the like are displayed on the multimedia monitor 14M by control of the control device 18.

The illumination sensor 20 detects the illumination of the periphery as the brightness of the periphery, and outputs the results of detection to the control device 18. In the present embodiment, on the basis of the results of detection of the illumination sensor 20, the control device 18 controls the luminances of the plural monitors 14 simultaneously. The brightness of the periphery of the vehicle is detected by the illumination sensor 20, but another sensor that reacts to light, such as a sensor for the amount of solar radiation or the like, may be used instead.

The control device 18 is structured by a microcomputer in which a CPU 18A, a ROM 18B, a RAM 18C and an I/O (input/output interface) 18D are respectively connected to a bus 18E.

Various types of programs, such as a program for carrying out display control that displays on the respective monitors 14 the captured images by the respective cameras 12, are stored in the ROM 18B. Control of display of the captured images onto the respective monitors, and the like are carried out due to programs that are stored in the ROM 18B being read out in the RAM 18C and being executed by the CPU 18A.

The rear camera 12B, the right lateral rear camera 12R, the left lateral rear camera 12L, the rearview mirror monitor 14I, the right side monitor 14R, the left side monitor 14L, the multimedia monitor 14M and the illumination sensor 20 are respectively connected to the I/O 18D. The control device 18 acquires the results of imaging of the respective cameras 12, and carries out, on the captured images, processings for display onto the respective monitors 14 (e.g., processings such as mirror image conversion that reverses the left and the right of the captured image, and the like), and displays the captured images on the respective monitors 14.

In a device that captures images of the rear region and the lateral rear regions of the vehicle by the cameras 12 and displays images on the monitors 14 as in the present embodiment, when time passes from daytime to evening, or in a place where the ambient light changes such as in a tunnel or the like, exposure adjustment of the cameras 12 and luminance adjustment of the monitors 14 are carried out, and optimal images are displayed. On the other hand, the brightness of the multimedia monitor 14M is also adjusted, and there would be a sense of incongruity if there is offset in the timings at which the brightnesses of these plural monitors 14 switch. Thus, in the present embodiment, on the basis of the results of detection of the single illumination sensor 20, the control device 18 carries out display control that simultaneously switches the luminances of the plural monitors 14, and, due thereto, suppresses a sense of incongruity that is due to offset in the adjustment timings of the luminances. Note that, here, “simultaneously” is not limited to the exact same time, and includes offset of a range that is such that a person cannot perceive the offset in the timings of the changing of the luminances of the respective monitors.

Concretely, in a case in which illumination that is greater than or equal to a predetermined luminance raising threshold value is detected as the brightness of the periphery by the illumination sensor 20, the control device 18 simultaneously adjusts the luminances of the plural monitors 14 to become a predetermined first luminance (high luminance). Further, in a case in which illumination that is less than a predetermined luminance lowering threshold value is detected as the brightness of the periphery by the illumination sensor 20, the control device 18 simultaneously adjusts the luminances of the plural monitors 14 to become a predetermined second luminance (a luminance that is lower than the first luminance). Due thereto, because the luminances of the respective monitors 14 are adjusted simultaneously, a sense of incongruity that is due to offset in the adjustment timings of the luminances can be suppressed.

Note that the luminance raising threshold value is a predetermined threshold value at which the luminances of the respective monitors 14 are raised, and the luminance lowering threshold value is a predetermined threshold value at which the luminances of the respective monitors are lowered. The same value may be used for the luminance raising threshold value and the luminance lowering threshold value, but it is preferable to use different values in order to prevent chattering of control. Further, the present embodiment describes carrying out luminance adjustment by comparing illumination, which serves as brightness, with a predetermined threshold value of illumination, but the present invention is not limited to this. For example, luminance adjustment may be carried out by comparing an amount of change in the brightness and a predetermined threshold value of an amount of change in the brightness.

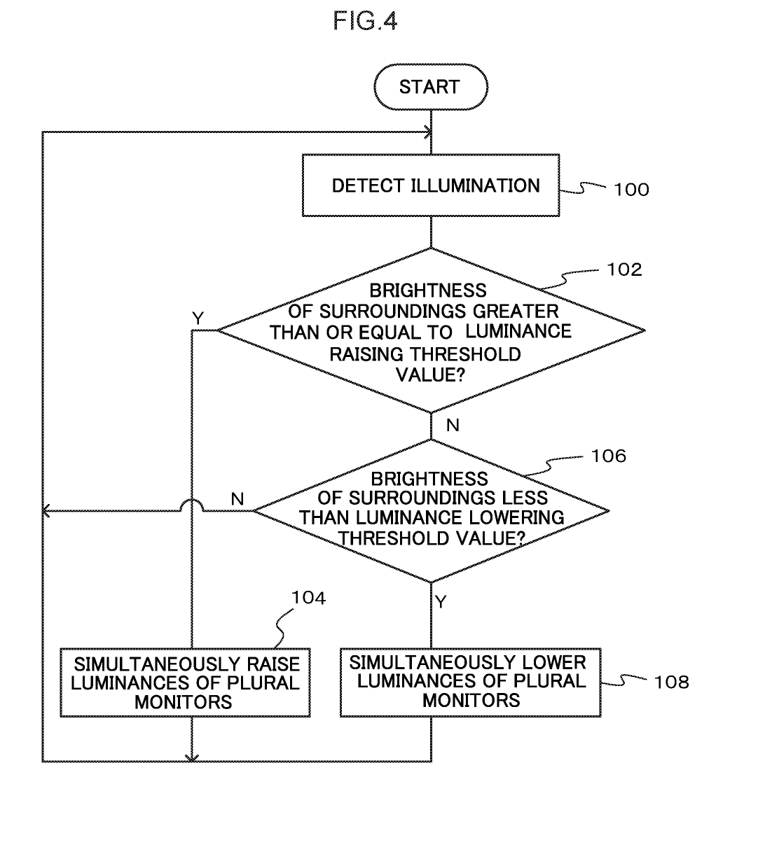

Concrete processings that are carried out at the control device 18 of the image display device 10 for a vehicle, which relates to the present embodiment and is structured as described above, are described next. In the present embodiment, different values are used for the luminance raising threshold value and the luminance lowering threshold value in order to provide a hysteresis characteristic. FIG. 4 is a flowchart showing an example of display control that is carried out at the control device 18 of the image display device 10 for a vehicle relating to the present embodiment. Note that the processing of FIG. 4 starts, for example, in a case in which an unillustrated ignition switch is turned on.

In step 100, the CPU 18A detects the illumination of the periphery by acquiring the results of detection of the illumination sensor 20, and the routine moves on to step 102.

In step 102, on the basis of the detected illumination, the CPU 18A judges whether or not the brightness of the periphery has changed to greater than or equal to the predetermined luminance raising threshold value. If this judgment is affirmative, the routine moves on to step 104, whereas if this judgment is negative, the routine moves on to step 106.

In step 104, the CPU 18A raises the luminances of the plural monitors 14 simultaneously, and the routine returns to step 100, and the above-described processings are repeated. For example, the luminances of the plural monitors 14 are raised so as to become the predetermined first luminance (high luminance). In a case in which the brightness of the periphery changes to greater than or equal to the luminance raising threshold value, the luminances of the plural monitors 14 are raised simultaneously in this way. Therefore, a sense of incongruity that is due to offset in the luminance adjustment timings per monitor 14 is suppressed.

In step 106, on the basis of the detected illumination, the CPU 18A judges whether or not the brightness of the periphery has changed to less than the predetermined luminance lowering threshold value. If this judgment is affirmative, the routine moves on to step 108, and if this judgment is negative, the routine returns to step 100, and the above-described processings are repeated.

In step 108, the CPU 18A lowers the luminances of the plural monitors 14 simultaneously, and the routine returns to step 100, and the above-described processings are repeated. For example, the luminances of the plural monitors 14 are lowered so as to become the predetermined second luminance that is a lower luminance than the first luminance. Due thereto, in a case in which the brightness of the periphery changes to less than the luminance lowering threshold value, the luminances of the plural monitors 14 are lowered simultaneously. Therefore, a sense of incongruity that is due to offset in the luminance adjustment timings per monitor 14 is suppressed also in cases of lowering the luminances.

Due to the control device 18 carrying out processing in this way, the luminances of the plural monitors 14 are adjusted on the basis of signals from the common illumination sensor 20, and therefore, the luminances of the respective monitors 14 can be changed simultaneously. Further, due to the luminances of the plural monitors 14 being changed simultaneously, a sense of incongruity that is due to offset in the luminance adjustment timings of the plural monitors 14 can be suppressed. Further, in a case in which the illumination is between the luminance raising threshold value and the luminance lowering threshold value, the previous luminance is maintained until the luminance is to be switched, and therefore, the luminance is prevented from being switched frequently.

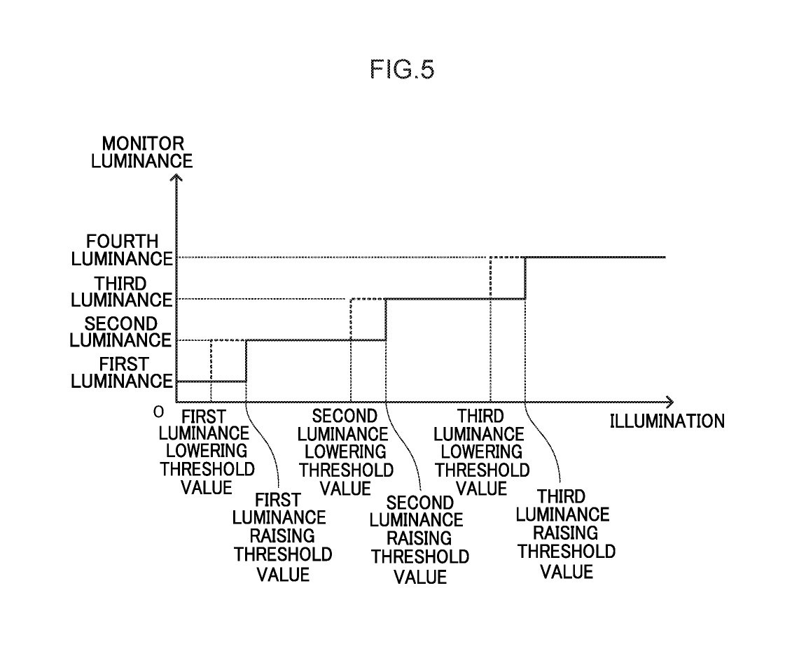

Note that, in the above-described embodiment, description is given by using as an example in which the luminance raising threshold value and the luminance lowering threshold value at which the luminances of the monitors 14 are adjusted are respectively one case, but the present invention is not limited to this. For example, as shown in FIG. 5, plural threshold values may be provided respectively (in FIG. 5, three threshold values each), and the luminances of the monitors 14 may be adjusted in accordance with the detected illumination. FIG. 5 shows an example in which there are a first through third luminance raising threshold value, and a first through third luminance lowering threshold value, and the luminances can be adjusted to a first through a fourth luminance. Further, it may be made such that the luminances are varied continuously in accordance with the magnitude of the illumination.

Further, the above-described embodiment describes an example in which the rearview mirror monitor 14I that functions as a rearview mirror, and the right side monitor 14R and the left side monitor 14L that function as outer mirrors, are provided as the first display unit. However, the present invention is not limited to this. For example, there may be a form in which only a structure that functions as the rearview mirror, or only structures that function as the outer mirrors, are provided as the first display unit.

Further, the display control, which is shown in FIG. 4 and is carried out at the control device 18 of the above-described embodiment, is described as software processing that is carried out by executing a program, but may be processing that is carried out by hardware. Or, the display control may be processing that combines both software and hardware. Further, the program that is stored in the ROM 18B may be stored on any of various types of storage media and distributed.

Moreover, the present disclosure is not limited to the above, and, other than the above, can, of course, be implemented by being modified in various ways within a scope of the claims.

What is claimed is:

1. An image display device for a vehicle, the image display device comprising:
an imaging unit provided within a vehicle cabin and capturing images of a periphery of a vehicle;
a first display unit displaying captured images that have been captured by the imaging unit;
a second display unit provided within the vehicle cabin separately from the first display unit;
a detecting unit detecting brightness of the periphery of the vehicle; and
a control unit configured to carry out display control, in a case in which brightness that is greater than or equal to a predetermined luminance raising threshold value is detected by the detecting unit, so as to simultaneously raise respective luminances of the first display unit and the second display unit, and to carry out display control, in a case in which brightness that is less than a predetermined luminance lowering threshold value, which is less than or equal to the luminance raising threshold value, is detected by the detecting unit, so as to simultaneously lower the respective luminances of the first display unit and the second display unit.

2. The image display device for a vehicle of claim 1, wherein:
the imaging unit captures images of a vehicle rear region by a camera provided at a vehicle rear portion, and
the first display unit displays, on a display screen that is disposed at an upper portion of a vehicle front region within the vehicle cabin, captured images of the vehicle rear region that have been captured by the imaging unit.

3. The image display device for a vehicle of claim 1, wherein:
the imaging unit captures images of vehicle lateral rear regions via side cameras provided at vehicle left and right sides, and
the first display unit displays, on a pair of side display screens that are disposed respectively at a left and a right of a front region within the vehicle cabin, respective captured images of the vehicle lateral rear region at the vehicle left side and of the vehicle lateral rear region at the vehicle right side, which have been captured by the imaging unit.

4. The image display device for a vehicle of claim 2, wherein:
the imaging unit captures images of vehicle lateral rear regions via side cameras provided at vehicle left and right sides, and
the first display unit displays, on a pair of side display screens that are disposed respectively at a left and a right of a front region within the vehicle cabin, respective captured images of the vehicle lateral rear region at the vehicle left side and of the vehicle lateral rear region at the vehicle right side, which have been captured by the imaging unit.

5. A non-transitory recording medium storing a program that is executable by a computer to perform an image display process for a vehicle, the process comprising:
capturing images of a periphery of a vehicle;
displaying, on a first display unit, images that have been captured;
displaying, on a second display unit, information that is different from the captured images;
detecting brightness of the periphery of the vehicle; and
in a case in which brightness that is greater than or equal to a predetermined luminance raising threshold value is detected, simultaneously raising respective luminances of the first display unit and the second display unit, and, in a case in which brightness that is less than a predetermined luminance lowering threshold value, which is less than or equal to the luminance raising threshold value, is detected, simultaneously lowering the respective luminances of the first display unit and the second display unit.

6. A non-transitory recording medium storing a program that is executable by a computer to function as:
an imaging unit provided within a vehicle cabin and capturing images of a periphery of a vehicle;
a first display unit displaying captured images that have been captured by the imaging unit;
a second display unit provided within the vehicle cabin and displaying information that is different from the captured images;
a detecting unit detecting brightness of the periphery of the vehicle; and
a control unit configured to carry out display control, in a case in which brightness that is greater than or equal to a predetermined luminance raising threshold value is detected by the detecting unit, so as to simultaneously raise respective luminances of the first display unit and the second display unit, and to carry out display control, in a case in which brightness that is less than a predetermined luminance lowering threshold value, which is less than or equal to the luminance raising threshold value, is detected by the detecting unit, so as to simultaneously lower the respective luminances of the first display unit and the second display unit.
